(19) United States
(12) Patent Application Publication
(10) Pub. No.: US 2016/0148285 A1
(43) Pub. Date: May 26, 2016

(54) Universal Real Property Grading System

(71) Applicant: Frank Joseph Kalata, Midland Park, NJ (US)

(72) Inventor: Frank Joseph Kalata, Midland Park, NJ (US)

(21) Appl. No.: 14/947,462

(22) Filed: Nov. 20, 2015

Related U.S. Application Data
(60) Provisional application No. 62/084,198, filed on Nov. 25, 2014.

(51) Int. Cl. G06Q 30/02

(52) U.S. Cl. CPC G06Q 30/0278; G06Q 50/16

(57) ABSTRACT

An embodiment of the invention relates to grading real property, and more particularly, relates to the method and information product of a real property grading system. In one form, the invention relates to the grading of real property on a local and global level. In another form, the present invention relates to the certification of a local grade and global grade to a property based upon an unbiased team physically surveying the property and inputting the survey results into the method and system of the present invention. The grading is presented in a universally recognized symbol and/or alphabetic letter format. The real property grade is presented in a two part sequence, one part being a local grade and the other part being a global grade.

### CROSS REFERENCE TO RELATED APPLICATIONS

This application claims the benefit of the provisional application (USPTO Application No. 62/084,198; EFS-ID Number 20798471) dated Nov. 25, 2014.

### FEDERALLY SPONSORED RESEARCH

None

### SEQUENCE LISTING

None

### FIELD OF INVENTION

An embodiment of the invention relates to grading real property, and more particularly, relates to the method and information product of a real property grading system.

### BACKGROUND PRIOR ART

Real estate or real property are the fields of this invention. One form of the invention lies in the application of an universally recognized grade to real property. Another embodiment relates to having real property certified by an unbiased and independent third party for the benefit of all.

Real property is typically considered one of the most valuable assets of any individual, entity, and/or government. To compare one real property with other similar real properties, a seller, buyer or tenant will need to review a great deal of information such as but not limited to price, quality, type, function, location, size and many other real property information. Several examples of this comparison process will now be presented for providing background information. The presented examples in no way limit the amount of potential real property comparisons.

One example of the current real property comparison process can be found in the search for a new property by a potential buyer. A buyer is tasked with reviewing several properties with either an agent or on their own. Only for this example, the buyer's criteria can be limited to specific size, type, function, quality, location, and price. While visiting the properties, the buyer will note specific differences between all of the compared properties which may not have been evident when reviewing the property listing. The buyer property review process has built-in inefficiencies by not clearly identifying property differences, such as but not limited to property conditions, property history, flooding, crime, and many more differences which cause the buyer a great deal of lost time. By utilizing a real property grading system, the buyer could have saved a great deal of time and effort by knowing the specific difference between compared properties.

Another example of the current real property comparison process can be found in a seller listing a real property. A seller is tasked with reviewing several similar real properties in order to set the potential selling price. Not knowing the specifics for similar properties, the seller may not be fully aware of specific price affecting details thereby causing the seller to inefficiently set the asking price. By utilizing a real property grading system, the seller would have been provided with a more accurate view on market conditions thereby allowing the seller to set a more market related selling price.

From these two and many more examples, a transparency problem in the real estate market has become evident.

The real estate industry has attempted to correct the transparency problem in the following ways:

1. A commercial building classification system by the International Building Owners and Managers Association (BOMA).

Commercial buildings are classified by BOMA in the following classifications (direct quote from http://www.boma.org/research/Pages/building-class-definitions.aspx):

### Class A

Most prestigious buildings competing for premier office users with rents above average for the area. Buildings have high quality standard finishes, state of the art systems, exceptional accessibility and a definite market presence.

### Class B

Buildings competing for a wide range of users with rents in the average range for the area. Building finishes are fair to good for the area. Building finishes are fair to good for the area and systems are adequate, but the building does not compete with Class A at the same price.

### Class C

Buildings competing for tenants requiring functional space at rents below the average for the area.

The BOMA classification system is limited because:
a. The BOMA classes are determined by an association of building owners and managers. The classification is in most cases not independently verified by an unbiased reviewer. The BOMA classifications also do not incorporate the input of other real estate industry members.
b. One of the main class distinctions between each other is rent paid in a specific building versus the immediate area's average. Rent should not be the sole determining factor in determining a specific class.
c. A scientific methodology is not applied to all properties to determine the class, which allows for a significant interpretation.
d. A universally applied standard is not permitted as the BOMA standards are primarily limited to large metropolitan areas mostly in the United States of America.
e. The BOMA classification system is strictly limited to commercial properties.

2. Property Rating and Ranking System and Method (US patent No. US 2007/0067180 A1 published Mar. 22, 2007)

The property rating system under US patent No. US 2007/0067180 A1 published Mar. 22, 2007 is limited by:
a. Using a numerical system. A numerical system of rating and ranking is not easily understood by all parties since the numerical values need to be cross referenced with control numbers in order to understand the underlying value.
b. Rating of leased and or rental space is not considered. Many transactions within the real estate industry occur via leasing or renting. Leasing should be part of any universal property ranking system.
c. Using “Your Needs” (Item 24 on FIG. 2 of US patent No. US 2007/0067180 A1 published Mar. 22, 2007). This ranking system provides more emphasis on the end user's needs. By placing additional weight on the end user, the ranking system can not be considered equal for all parties.
d. Using “Money value” (Item 43 on FIG. 4a of US patent No. US 2007/0067180 A1 published Mar. 22, 2007). This ranking system provides more emphasis on the property's money value. By placing additional weight on the property's money value, the ranking system is dependent on unstable market valuations.
e. No differentiation between local and global. This ranking system does not differentiate between local and global ratings. A single rating is generated under US patent No. US 2007/0067180 A1 published Mar. 22, 2007, which does not express any specificity towards local and global real estate markets.

To correct the limitations of current classifications systems, an unbiased universally acknowledged real property grading system is needed.

### Advantages

The advantages of a universal real property grading system would address one or more aspects of the prior art. The following advantages of a universal real property grading system would address:

1. Buyers being unable to determine specific differences between potential properties. Having a review by an unbiased third party would provide the buyer with a grade on each of the potential properties. The buyer can then limit his or her property choices to the properties which fall within the buyer's target grade.

2. Sellers having a better understanding of their property in comparison to other properties. Receiving an unbiased third party review of similar properties would provide Sellers with comparison information about their own property. A more efficient real property market could occur due to a greater understanding of all properties.

3. International Building Owners and Managers Association (BOMA) classification issues. Subjectivity and interpretive limitations found in BOMA classes would not be present in a universal real property grading system since the property review process will not be limited to building owners and building managers.

4. Unclear understanding of the numerical values within the property rating and ranking system (under US patent No. US 2007/0067180 A1 published Mar. 22, 2007). By providing a simplified alphabetical grade for each real property the general public should quickly understand a real property's grade.

5. Removing the end user's needs within the property rating and ranking system (under US patent No. US 2007/0067180 A1 published Mar. 22, 2007). By removing the end user's input into a real property's rating, the grading system becomes more open to public definition.

6. Removing the money value within the property rating and ranking system (under US patent No. US 2007/0067180 A1 published Mar. 22, 2007). By removing the money value input into a real property's rating, the grading system becomes less dependent on unstable market valuations.

7. Providing a local and global real property grade. Each surveyed property will receive two real property grades: one for a local scale comparison, and the other for a global real property comparison.

Thus the above listed advantages and many more aspects of the universal real property grading system can be found in the system's simplistic and unbiased nature. These and other advantages of one or more aspects will become apparent from a consideration of the ensuing description and accompanying drawings.

### SUMMARY

In order to provide the real property market with a tool to qualify certain properties as being “better than” others of similar quality, type, function, size and or value, the inventor realized a tool is needed. A universal real property grading system would provide humanity with an unbiased grading system for all real property. By providing people with a real property grading tool, transparency will arise in the real property industry thereby creating an efficient real property field.

The grading of real property is similar to the action of rating an issued corporate or government bond. Before purchasing a bond an investor can review the bond's grade (from an independent review), which provides the investor with an understanding of possible risks and value in comparison to other similar bonds. The universal real property grading system would act in a similar manner by applying two grades to a real property, one being a local real property grade and the other being a global real property grade. The local real property grade would compare the property to similar properties within a close proximity. The global real property grade would compare the property to similar properties on a worldwide basis.

One adaptation of the invention is a system of calculating a universally recognized real property grade. The method of calculation is based on setting a standard range of values which any specific property can achieve. The highest and lowest real property standard will be consistent on a local and global basis. Real property specific inputs will be based upon an industry wide agreement on requirements.

Another adaptation of the present invention is a method of applying real property grades to a multitude of properties based on an alphabetical or universal symbol system.

In essence, the invention is a third party verified and unbiased grading system for real property on a global and local basis.

### BRIEF DESCRIPTION OF THE SEVERAL VIEWS OF THE DRAWINGS

Having thus described an embodiment of the invention in general terms, reference will now be made to the accompanying drawings, which are not necessarily drawn to scale, and where in:

FIG. 1 is a schematic block diagram of a system according to an example embodiment of the invention;

FIG. 2 is a schematic block diagram of a system according to an example embodiment of the invention;

FIG. 3 is a schematic block diagram of a system according to an example embodiment of the invention;

FIG. 4 illustrates, in more detail, an example embodiment of the invention;

FIG. 4A illustrates, in more detail, an example embodiment of the invention;

FIG. 5 is a schematic block diagram of a local grade system according to an example embodiment of the invention;

FIG. 6 is a schematic block diagram of a global grade system according to an example embodiment of the invention;

FIG. 7 is a schematic network diagram of a system according to an example embodiment of the invention;

FIG. 8 is an illustration of a view of virtual information provided by an augmented reality application (under US patent No. US 2012/0075341 A1 published Mar. 29, 2012) of a system according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “property”, “real estate” and similar terms may be used interchangeably to refer to real property in accordance with embodiments of the invention. Additionally, as used herein, the terms “grade”, and similar terms may be used interchangeably to refer to a real property grade in accordance with embodiments of the invention.

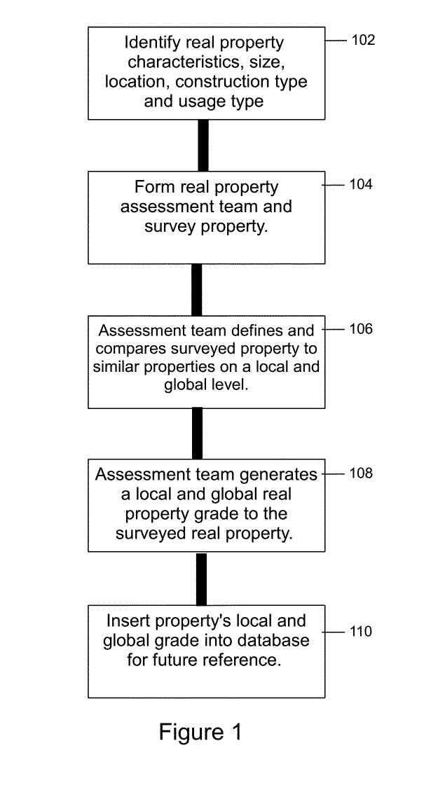

FIG. 1. is a schematic system diagram of in which an identified real property 102 is surveyed by an assessment team 104 who surveys the real property 106 to similar properties on a local and global level. Once the survey is completed a local and global real property grade is applied 108 and inserted into a database for future reference 110. Identification of real property 102 includes, but is not limited to characteristics, size, location, construction type, and usage type. Surveying a property with an assessment team 104 includes, but is not limited to real property owners 208, real property tenants 210, architects and engineers 212 and 310, property managers 214, home builders 208, home inspectors 314, real estate brokers and agents 216 and 312, and the general public 218 and 316. After surveying the property the assessment team defines 106 the identified property's 102 results to other similar properties on a local and global level. The assessment team applies a global and local grade 108 to the property and inputs the property grade to a database for reference on other properties 110.

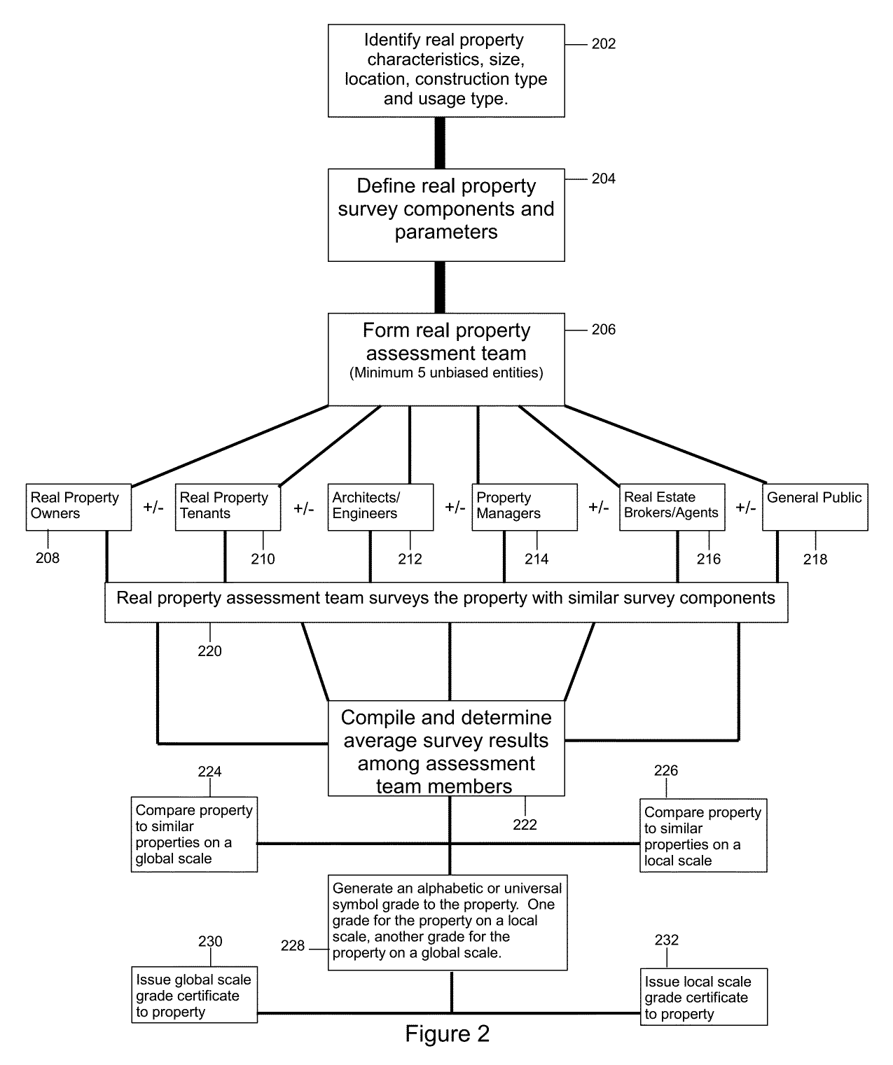

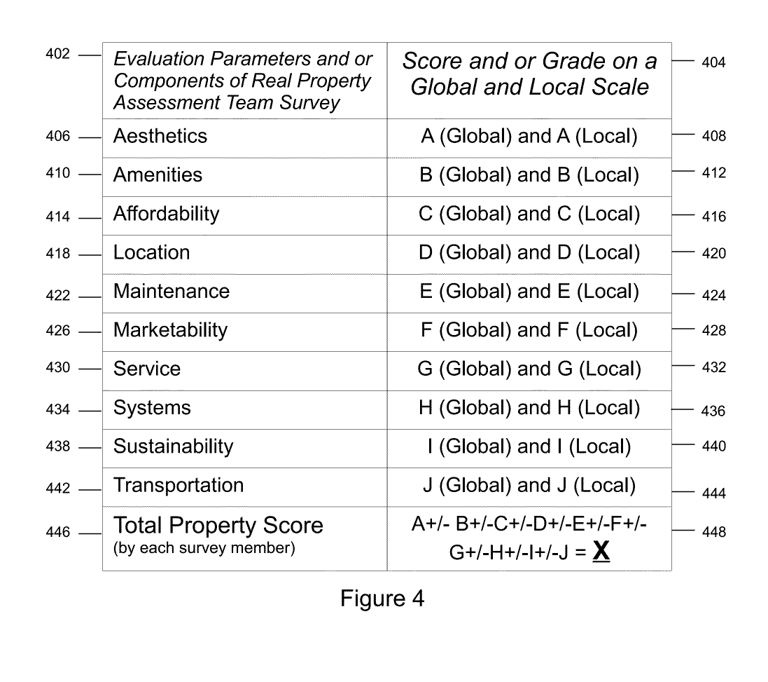

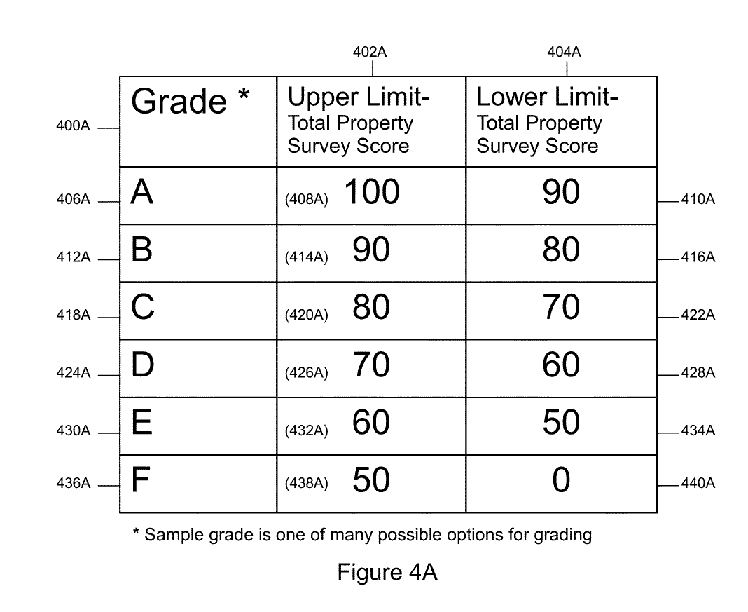

FIG. 2 is a schematic system diagram, showing more detail than FIG. 1 of an example embodiment of the invention. FIG. 2 is a system which may but is not limited to “other than residential” real property. A real property is first identified 202 by including, but not limited to characteristics, size, location, construction type, and usage type. Once the property is identified 202; property survey components and parameters are defined 204 for the assessment team. Property survey components will include, but is not limited to evaluation parameters similar to the items in FIG. 4; aesthetics 406, amenities 410, affordability 414, location 418, maintenance 422, marketability 426, service 430, systems 434, sustainability 438, and transportation 442. After defining property survey components, a property review team is formed 206 of various real property professionals who may include but is not limited to real property owners 208, real property tenants 210, architects and engineers 212, property managers 214, real estate brokers and or agents 216, and members of the general public 218. The property assessment team then proceeds to survey the property 220 using the property components and parameters 204. Upon completion of the surveys, the property assessment team 206 then compiles the survey results to determine the survey averages among the assessment team members 222. After compiling the real property survey results 222, the property assessment team compares the property to other properties on a global scale 224 and on a local scale 226. Once the property comparisons are completed (224 and 226), an alphabetic or universal symbol grade is applied to the surveyed property both on a global scale and local scale 228. The property assessment team then issues a certification on the property defining its real property grade on a global scale 230 and on a local scale 232.

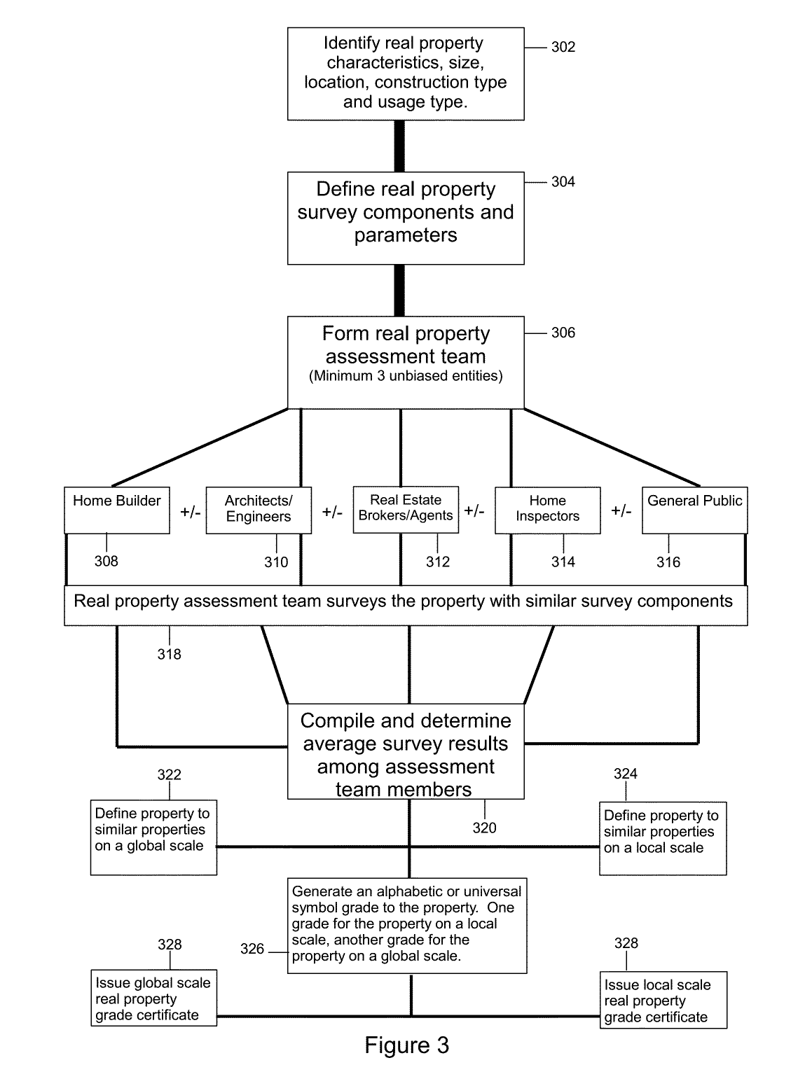

FIG. 3 is another schematic system diagram, showing more detail than FIG. 1 of an example embodiment of the invention. FIG. 3 is a system which may but is not limited to “residential or other smaller” real property. A property is first identified 302 by including, but not limited to characteristics, size, location, construction type, and usage type. Once the property is identified 302; property survey components and parameters are defined 304 for the assessment team. Property survey components will include, but is not limited to evaluation parameters similar to the items in FIG. 4; aesthetics 406, amenities 410, affordability 414, location 418, maintenance 422, marketability 426, service 430, systems 434, sustainability 438, and transportation 442. After defining property survey components, a property review team is formed 306 of various real property professionals who may include but is not limited to home builders 308, architects and engineers 310, real estate brokers and or agents 312, home inspectors 314, and members of the general public 316. The property assessment team then proceeds to survey the property 318 using the property components and parameters 304. Upon completion of the surveys, the property assessment team 306 then compiles the survey results to determine the survey averages among the assessment team members 320. After compiling the property survey results 320, the property assessment team compares the property to other properties on a global scale 322 and on a local scale 324. Once the property comparisons are completed (322 and 324), an alphabetic or universal symbol grade is applied to the surveyed property both on a global scale and local scale 326. The property assessment team then issues a certification on the property defining its real property grade on a global scale 328 and on a local scale 330.

Referring to FIG. 4 which illustrates, in more detail, an example embodiment of the invention; FIG. 4 is one of many possible evaluation parameters and or components of a real property assessment team survey. In order to compare real property a set of similar parameters and or survey components should be used from the real property field. The listed parameters and or components (406, 410, 414, 418, 422, 426, 430, 434, 438, 442) breaks down the survey into one of many possible comparison items. Aesthetics 406 relates to the real property's aesthetic value in relation to other similar real properties. During the real property survey (220 and 318), the real property assessment team member (206 and 306) determines the aesthetic score and or grade 408 for the real property. Amenities 410 relates to the real property's amount of amenities in relation to other similar real properties. During the real property survey (220 and 318), the real property assessment team member (206 and 306) determines the amenities score and or grade 412 for the real property. Affordability 414 relates to the real property's affordability in relation to other similar real properties. During the real property survey (220 and 318), the real property assessment team member (206 and 306) determines the affordability score and or grade 416 for the real property. Location 418 relates to the real property's location in relation to other similar real properties. During the real property survey (220 and 318), the real property assessment team member (206 and 306) determines the location score and or grade 420 for the real property. Maintenance 422 relates to the real property's maintenance in relation to other similar real properties. During the real property survey (220 and 318), the real property assessment team member (206 and 306) determines the maintenance score and or grade 424 for the real property. Marketability 426 relates to the real property's marketability in relation to other similar real properties. During the real property survey (220 and 318), the real property assessment team member (206 and 306) determines the marketability score and or grade 428 for the real property. Service 430 relates to the real property's serviceability in relation to other similar real properties. During the real property survey (220 and 318), the real property assessment team member (206 and 306) determines the serviceability score and or grade 432 for the real property. Systems 434 relates to the real property's systems in relation to other similar real properties. During the real property survey (220 and 318), the real property assessment team member (206 and 306) determines the systems score and or grade 436 for the real property. Sustainability 438 relates to the real property's sustainability in relation to other similar real properties. During the real property survey (220 and 318), the real property assessment team member (206 and 306) determines the sustainability score and or grade 440 for the real property if used. Transportation 442 relates to the real property's transportation availability in relation to other similar real properties. During the real property survey (220 and 318), the real property assessment team member (206 and 306) determines the transportation score and or grade 444 for the real property if used. Once all survey parameters and or components are determined by the real property assessment team member (206 and 306) a total property score 446 is established by each survey member demonstrating one of many possible formulas 448. The real property assessment team member's total property score 446 will become a part (506, 508, 510, 512, 514 and 606, 608, 610, 612, 614) of the total property survey score (516, 518, 616, 618) which assist in generating the local real property grade (520) and global real property grade (620).

Referring to FIG. 4A which illustrates, in more detail, an example embodiment of the invention; FIG. 4A is one of many possible grading options of a real property assessment team survey. The listed grades (406A, 412A, 418A, 424A, 430A, 436A) breaks down the total property survey scores 518 and 618 into an upper limit 402A and a lower limit 404A. The total property survey scores 518 and 618 from the assessment team surveys are defined within the upper limit 402A and the lower limit 404A which relate to the real property grades (406A, 412A, 418A, 424A, 430A, 436A). To provide one of many possible grading examples we will demonstrate how the listed samples (406A, 412A, 418A, 424A, 430A, 436A) relate to each other. Grade “A” 406A would be the top grade, when the total property survey score 518 and 618 equals to or falls within the upper and lower limits (408A and 410A). Grade “B” 412A would be one grade lower than the top grade 406A, when the total property survey score 518 and 618 equals to or falls within the upper and lower limits (414A and 416A). Grade “C” 418A would be two grades lower than the top grade 406A, when the total property survey score 518 and 618 equals to or falls within the upper and lower limits (420A and 422A). Grade “D” 424A would be three grades lower than the top grade 406A, when the total property survey score 518 and 618 equals to or falls within the upper and lower limits (426A and 428A). Grade “E” 430A would be four grades lower than the top grade 406A, when the total property survey score 518 and 618 equals to or falls within the upper and lower limits (432A and 434A). Grade “F” 436A would be the lowest grade, when the total property survey score 518 and 618 equals to or falls within the upper and lower limits (438A and 440A). This example is one of many possible options for generating a real property grade 520 and 620 for both local real property grades 522 and global real property grades 622.

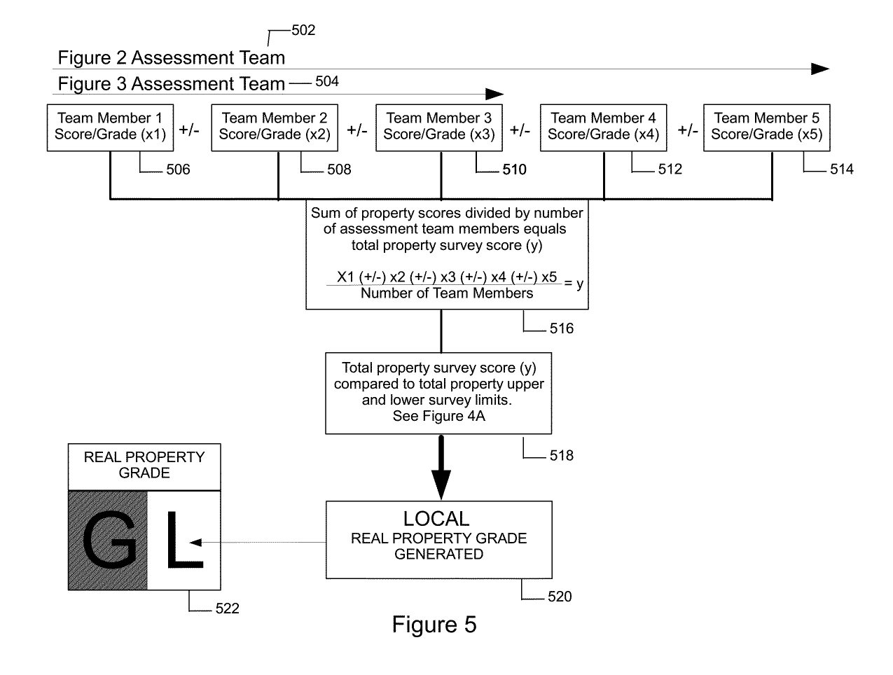

FIG. 5 is schematic block diagram of a local grade system according to an example embodiment of the invention. After completing the real property survey (220 and 318) the real property assessment team (206, 306, 502, or 504) compiles the collected total property scores (502 and 504) of all team members. In an example of FIG. 2, one embodiment of the invention, would use a minimum of five team members (506, 508, 510, 512, and 514). In an example of FIG. 3, one embodiment of the invention, would use a minimum of three team members (506, 508, and 510). Upon compiling the real property assessment team survey results, the sum of all total property scores 448 is divided by the amount of team members 516 in order to determine the total real property survey score 518. Once the total real property survey score is defined 518 a local real property grade 520 is generated when compared to the total property survey score upper limit 402A and the lower limit 404A, which is a portion of the total real property grade 522.

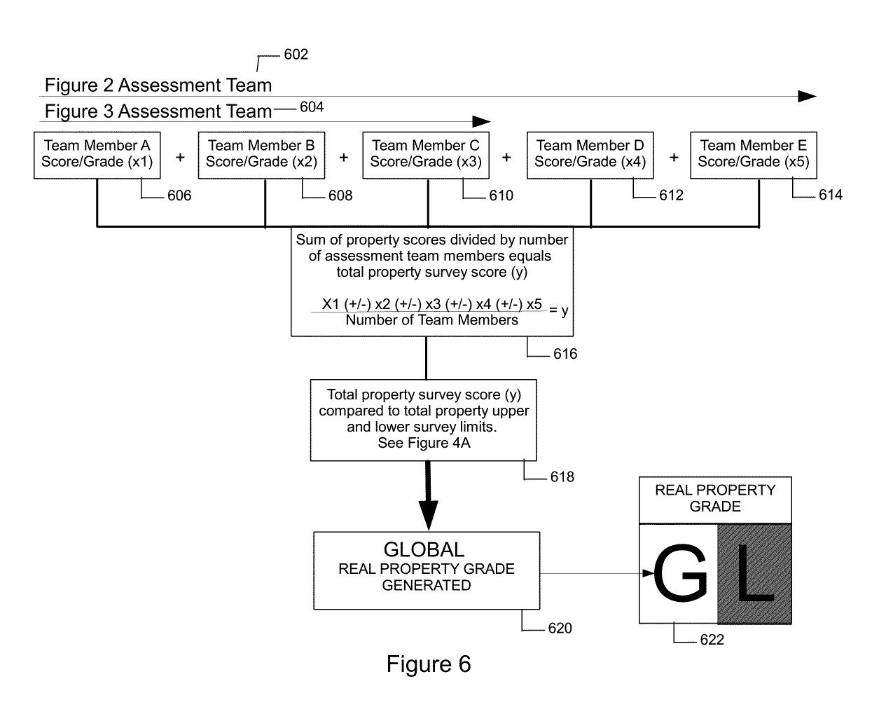

FIG. 6 is schematic block diagram of a global grade system according to an example embodiment of the invention. After completing the real property survey (220 and 318) the real property assessment team (206, 306, 602, or 604) compiles the collected total property scores (602 and 604) of all team members. In an example of FIG. 2, one embodiment of the invention, would use a minimum of five team members (606, 608, 610, 612, and 614). In an example of FIG. 3, one embodiment of the invention, would use a minimum of three team members (606, 608, and 610). Upon compiling the real property assessment team survey results, the sum of all total property scores 448 is divided by the amount of team members 616 in order to determine the total real property survey score 618. Once the total real property survey score is defined 618 a global real property grade 620 is generated when compared to the total property survey score upper limit 402A and the lower limit 404A, which is a portion of the total real property grade 622.

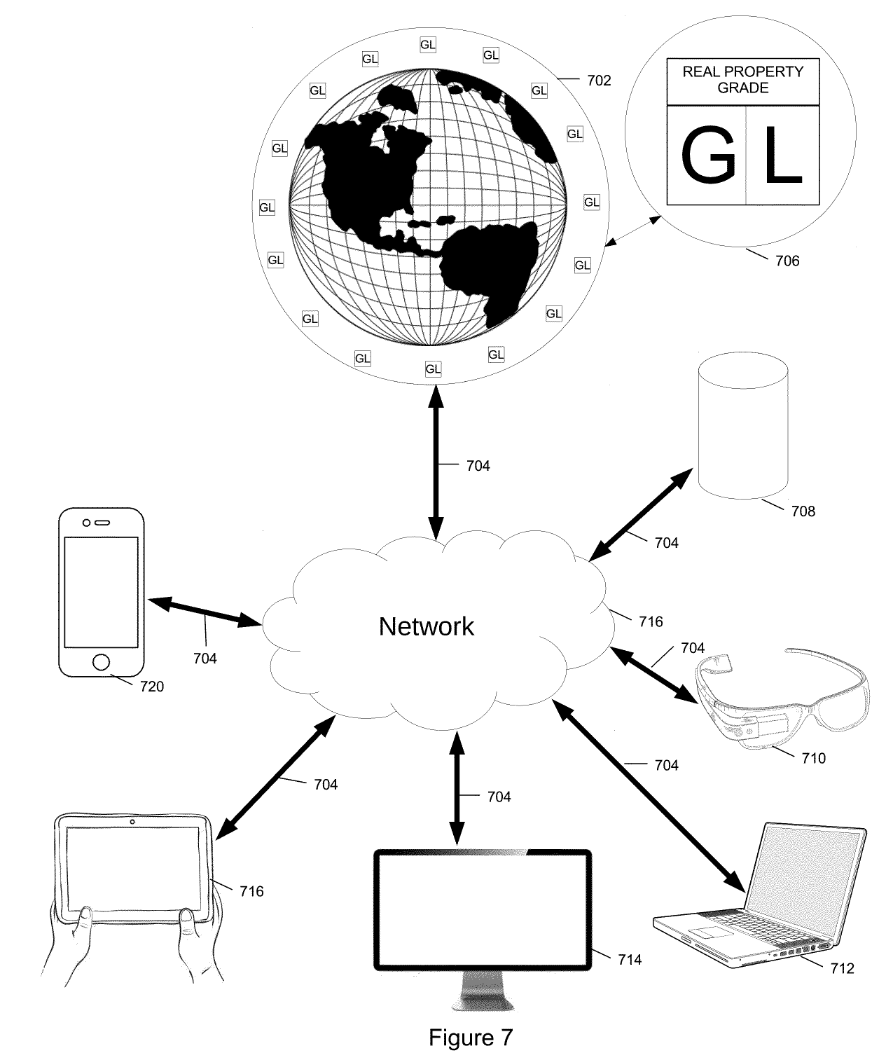

Referring to FIG. 7 which is a schematic network diagram of a system according to an example embodiment of the invention. FIG. 7 is one of many network options in implementing a globally accessed real property grading system. A globally recognized real property system 702 would consist of applying a real property grade 706 to all real property. Once real property grades (522 and 622) are generated by the real property assessment team (206 and 306) the information would be input into real property information network 716. The real property information would be communicated via a network 716 to a multitude of inputs and outputs via network connectivity 704. One of many examples of the real property grading system's inputs and outputs may include but is not limited to databases 708, wearable technology 710, laptop computers 712, desktop computers 714, tablets 716, and smart phones 720. The network 716 information will allow individuals to access the real property grading system via any computing device.

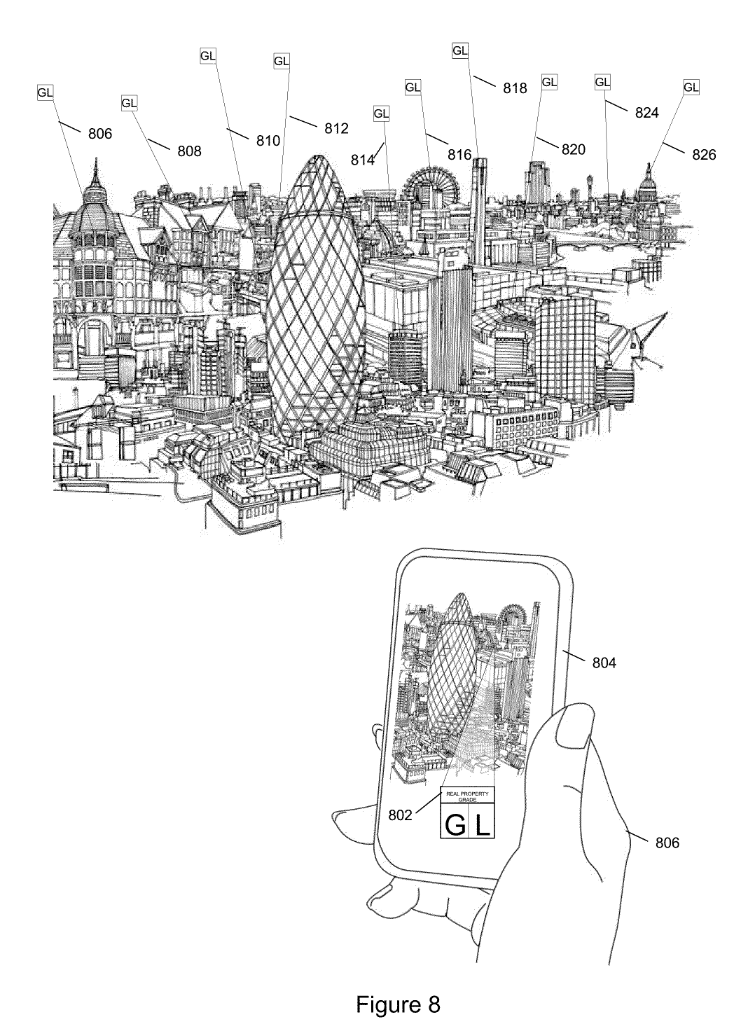

One of many sample embodiments of the invention is presented in FIG. 8 which builds upon the notion of augmented reality (under US patent No. US 2012/0075341 A1 published Mar. 29, 2012). In FIG. 8, a potential consumer of the real property grading system 806 could use their smartphone 804 or any other mobile computing device in order to access the real property grade 802 for any specific real property. One example of the invention could occur in a large metropolitan area where the consumer could see the real property grades for a multitude of real property types including but not limited to: agricultural 806, commercial 808, residential 810, educational 812, government 814, industrial 816, military 818, parking and storage 820, transport 824, infrastructure 824, religious 826, vacant land 828, and every other type of real property.

That what is claimed:

1. A method comprising:
identification of property characteristics, type, function, location and size
forming an unbiased real property assessment team of industry professionals
selection of real property survey components for similar real properties
surveying the real property with a real property assessment team
defining total property score by each surveying team member both on a local and global basis
generating a real property grade on a local and global basis based upon a total property survey score
certifying real property grade on a local and global basis
inputting the real property grade into a database for future reference

2. A method as claimed in claim 1, wherein a maximum and a minimum total property score is determined based on survey parameters and or components both on a local and global level.

3. A method as claimed in claim 1, where in all surveying members are unbiased and have no current and or past relationship with the surveyed real property.

4. A method as claimed in claim 1, wherein the survey parameters and or components comprise any combination of but is not limited to:
aesthetics
amenities
affordability
location
maintenance
marketability
service
systems
sustainability
transportation

5. A method as claimed in claim 1, wherein the survey parameters and or components are subjective and or objective

6. A method as claimed in claim 1 of defining a multitude of real properties, which may include the following steps:
calculating a local real property grade on the first real property
calculating a global real property grade on the first real property
calculating a local real property grade on the second real property
calculating a global real property grade on the second real property
comparing the first and second real property local and global grades

7. A method as claimed in claim 1, wherein at least one real property grade is calculated

8. A method as claimed in claim 1, wherein the global and local real property grade is presented in an alphabetical or universal symbol format.

9. A computer program created to determine a real property grade, the computer program could comprise of but is not limited to:
identification of property characteristics, type, function, location and size
tracking an unbiased real property assessment team of industry professionals
selection of real property survey components for similar real properties
storing survey information from all members of a real property assessment team
calculating a total property score by each surveying team member both on a local and global basis
generating a real property grade on a local and global basis based upon a total property survey score
certifying real property grade on a local and global basis
recording real property grades for future reference and comparison on other real properties
generation of a visual symbol of the real property grades
capable of an endless amount of real property information being stored and or used
being accessible via the Internet and or all mobile computing devices

10. A computer program as claimed in claim 9, where in a maximum and minimum real property grade can be determined by real property survey assessment parameters and or components

11. A computer program as claimed in claim 9, where in a real property assessment team member could input his or her determinations on assessment parameters and or components

12. A computer program as claimed in claim 9, wherein the survey evaluation parameters and or components comprise any combination of but not limited to:
aesthetics
amenities
affordability
location
maintenance
marketability
service
systems
sustainability
transportation

13. A computer program as claimed in claim 9, which includes the following steps:
calculating a local real property grade on the first real property
calculating a global real property grade on the first real property
calculating a local real property grade on the second real property
calculating a global real property grade on the second real property
generating the first and second real property local and global grades
creating a historical record of previous real property grades including both global and local real property grades.

14. A computer program as claimed in claim 9, wherein the first value for the evaluation parameter component is a maximum value and the second value for the evaluation parameter component is a minimum value.

15. A computer program as claimed in claim 9, wherein the value for the evaluation parameter component is user selectable.

16. A computer program as claimed in claim 9, wherein the evaluation parameter component is objective and or subjective.

17. A computer program as claimed in claim 9, wherein the real property grade can be sorted by but not limited to:
Real Property Type
Real Property Function
Real Property Size
Real Property Location
Evaluation Parameter Component global grade
Evaluation Parameter Component local grade
Total Real Property Score
Total Real Property Survey Score
Real Property Grade—Global
Real Property Grade—Local

18. A computer program as claimed in claim 9, where in the real property information as defined by the method claimed in claim 1, will be accessible via augmented reality (under US patent No. US 2012/0075341 A1 published Mar. 29, 2012)

19. A structured method as claimed in claim 1 to provide real property grades, both on a local and global basis, including but not limited to the computer program as claimed in claim 9.

20. A structured method as claimed in claim 1, wherein the computer program as claimed in 9 communicates with all involved participants.
